(19) United States
(12) Patent Application Publication
(10) Pub. No.: US 2016/0118653 A1
(43) Pub. Date: Apr. 28, 2016

(54) ANODE ELEMENT FOR ELECTROCHEMICAL REACTIONS

(71) Applicants: Michael BRENER, Richmond Hill (CA); Mark FERTMAN, Toronto (CA)

(72) Inventors: Michael BRENER, Richmond Hill (CA); Mark FERTMAN, Toronto (CA)

(21) Appl. No.: 14/757,538

(22) Filed: Dec. 23, 2015

Related U.S. Application Data
(63) Continuation of application No. PCT/CA2014/000527, filed on Jun. 27, 2014.

(30) Foreign Application Priority Data
Jun. 28, 2013 (EP) 13174188.6

(51) Int. Cl. H01M 4/38; C25B 1/04; H01M 6/34

(52) U.S. Cl. CPC H01M 4/381; H01M 4/38; H01M 6/34; C25B 1/04

(57) ABSTRACT

Anode element for a fuel and electrical power generator unit, the anode element being formed as a massive metal body made from at least one of magnesium, zinc, or aluminum, or an alloy of at least one of these and comprising a porous activated surface layer.

### CROSS-REFERENCE TO RELATED APPLICATIONS

This application is a continuation application of PCT International Application No. PCT/CA2014/000527 filed Jun. 27, 2014 which claims the benefit of European Application No. 13174188.6 filed Jun. 28, 2013, the contents of each which are incorporated herein by reference thereto in their entirety.

### FIELD

The present invention relates to an anode element for use in generation of hydrogen from an electrolytic hydrogen source, processes related to hydrogen generation using the anode element, and a process for making such anode element.

### BACKGROUND

Electrochemical energy sources, which use seawater as an electrolyte, are suited for a number of applications. Examples have been ships and other watercraft, electronic devices, toys and the like, and highly promising future applications can be seen on a large scale in the growing field of renewable energies. Various types of so-called seawater cells are known.

One of the known types of a seawater cell is a magnesium/oxygen battery comprising a magnesium anode, which utilises seawater as an electrolyte as well as oxygen dissolved in the seawater as an oxidizing agent. The chemical processes taking place in this cell as follows:

On the anode, magnesium is dissolved according to the equation

2Mg=2Mg²⁺+4e⁻

On the cathode, oxygen is consumed according to the equation

O₂+2H₂O+4e⁻=4OH⁻

Summarizing, these processes can be described in a simplified manner as follows:

2Mg+O₂+2H₂O=2Mg(OH)₂

The anode material can be, as exemplified above, magnesium, but it can also be Aluminum, zinc, and a mixture of these elements, and alloys thereof.

U.S. Pat. No. 4,822,698 discloses an energy cell/battery for use in seawater. This battery works according to the aforementioned electrochemical reactions, with magnesium or zinc being used as an anode material and an oxygen electrode as a cathode. The oxygen supplied to the cathode is dissolved in the seawater. This seawater battery consists of a cylindrical oxygen electrode cathode. The structure comprises single or several anode rods, which contain magnesium or zinc. The oxygen electrode is similar to those used in other batteries, e.g., in U.S. Pat. No. 6,372,371 B1.

U.S. Pat. No. 5,405,717 discloses a seawater cell, the power of which is slightly increased compared to that of U.S. Pat. No. 4,822,698. This power increase is caused by the effect of waves, which increases the flow of the seawater through the cathode so as to supply oxygen. The cell structure includes water flow conducting means, which allows the water to flow through the cell. U.S. Pat. No. 5,225,291 discloses a seawater battery which is operable with or without dissolved oxygen due to the use of a hybrid cathode. U.S. Pat. No. 5,427,871 relates to galvanic seawater cells and batteries, respectively, which use oxygen dissolved in the seawater as an oxidizing agent.

Another galvanic type of seawater battery, in which normally seawater is used as an electrolyte, comprises a magnesium anode and a cathode of copper chloride or silver chloride. These long-term batteries do not require oxygen dissolved in seawater; however, they have a small output energy density, are generally heavy, and have large spatial requirements. For example, a Mg/CuCl battery with one watt-year as an output energy may have a length of 8½ feet, a diameter of 9 inches, and a weight of approximately 100 pounds. Moreover, these batteries have a limited flexibility with respect to the design and are restricted to a longitudinal shape. Examples are described in U.S. Pat. No. 4,601,961, U.S. Pat. No. 5,288,564, or U.S. Pat. No. 6,656,628 B2.

Metal-air cells are known primary cells comprising an anode made of metal, e.g., of aluminum, magnesium or zinc, and an air cathode which is disposed with a small spacing from the metallic anode, but does not touch the same. A suitable electrolyte is provided in a space between the cathode and anode. The anode is immersed into the electrolyte. Different embodiments of such batteries and methods for the production and use of such batteries are known from the prior art, compare, for example, U.S. Pat. No. 5,004,654, U.S. Pat. No. 5,360,680, U.S. Pat. No. 5,376,471, U.S. Pat. No. 5,415,949, U.S. Pat. No. 5,316,632. Typical metal-air batteries and metal-air fuel cells, respectively, are described, for example, in U.S. Pat. No. 6,127,061.

Besides their use in the above-referenced electrical energy generators, magnesium or electrochemically related metals and their alloys, placed in aqueous solutions, have been used to generate hydrogen, which is being considered as an important energy source of the future. Basic concepts in this regard have been disclosed e.g. in U.S. Pat. No. 3,256,504; U.S. Pat. No. 3,892,653 or U.S. Pat. No. 4,436,793 and further developed e.g. in US 2008/0268306. All of these prior art documents disclose hydrogen generators containing alternating plates of magnesium or an electrochemically comparable material and plates of an electrochemically passive material in an electrolyte, for example a saline solution. There are magnesium-air primary batteries technologies in existence, however rechargeable magnesium batteries have not yet been commercially successful, both due to the low reversibility of the Mg electrode/electrolyte ion transfer mechanism because of the passivating oxide layer on the Mg anode, the lack of suitable high-conductivity Mg++ ion conducting electrolytes, and the need for a high-voltage cathode system.

### SUMMARY

Based on the above-described prior art it is an object of the present invention to provide an improved energy source, which is constructed in a simple manner and is highly efficient, and applicable for many purposes.

It is an aspect to look for an improved anode element for use in the above-specified type of hydrogen and/or electrical power generator, which in particular can improve the performance of hydrogen generation and in particular the response behaviour of such generation (e.g. in a generator unit) during an initial stage of its operation and/or which enables or at least facilitates the use of a hydrogen source (low concentration electrolyte or even tap water) in such generator unit. It is a further aspect of the invention, to consider treatment and resulting surface configuration of the anode element surface, which can provide advantageous effects in the generation of hydrogen gas from the hydrogen source (e.g. electrolytic solution of a generator unit). It is recognised that the anode element can be a universal anode for use in reactions in an electrochemical cell (e.g. the anode element is exposed to an electrolyte to promote operation as 1) the generation of a gas (e.g. hydrogen) when operated as a fuel cell and/or 2) the generation of electricity when operated as a battery. It is recognised that the anode can be configured as a consumable (also referred to as a sacrificial) anode element in the electrochemical reaction provided by the generation cell (e.g. hydrogen producing cell, electricity producing cell, etc.). As such, the anode element can be used in hydrogen extraction when the electrolyte exposed to the anode element is provided as a hydrogen source. Further, it is recognised that in electro chemical systems, the anode element can play a different role other than hydrogen extraction, as the electrochemical properties of the anode element for power generation as a byproduct of the electrochemical reaction involving consuming of the metal material of the anode element during electrify generation can be used a battery or energy generating system/cell.

Also, the hydrogen source can be substituted as a generic electrolyte that can be exposed to the anode element for the purposes of breaking down the electrolyte into its constituent parts, in view of electrolysis in operation of the anode element (e.g. consumption of the metal material composing the anode element body). Alternatively, the hydrogen source can be substituted as a generic electrolyte that can be exposed to the anode element for the purposes of the production of electricity when used as a battery in operation of the anode element (e.g. consumption of the metal material composing the anode element body).

Provided are magnesium or its alloys pretreated for introduced porosity on an exterior surface as a configured anode element, and/or activation of the surface using preservation of an activation material of the metal material comprising the formed pores of the porosity, and/or the porous and activated surface layer plated (e.g. distributed micro surface layer deposits, localized macro-regions of metals deposited on the surface layer, etc.) with metals acting as catalysts providing maintaining of low conductivity during idling and upon getting a demand from a consumable hydrogen source (e.g. Motor/Engine). As such the whole anode surface layer can become highly conductive for use as a consumable/sacrificial anode in an electrochemical reaction with a hydrogen source of other electrolytic solution to which the anode is exposed.

Surprisingly the inventors found that providing the anode element with a porous (e.g. micro- or nanoporous) and activated surface layer results in considerable improvements in operation during the production of hydrogen. It is recognised that in the electrical generator unit, hydrogen can be produced as a by-product of the electrical generation. Moreover, at least in specific arrangements including suitable catalyser elements (e.g. presence of an activation element preserved in the porous structure of the surface layer) even the overall device performance (hydrogen output and/or electrical power output per device volume units or time units) can be improved.

In an embodiment of the anode element, the micro- or nanoporous activated surface layer comprises a halide as an activation element, in particular chloride, of the respective metal or metal alloy contained in the anode material. In other embodiments, resulting from activation mechanisms which are not based on hydrogen halides, the surface layer can comprise other inorganic or organometallic components as the activation element, which facilitate the development of hydrogen from an aqueous solution at its interface with the activated surface layer of the anode element.

In a further embodiment, the massive metal body is in the overall shape of a sheet or plate or ingot and comprises two opposing micro- or nanoporous activated surface layers. In alternative embodiments, more specifically in embodiments wherein the hydrogen source liquid contacts only one surface of a hydrogen developing sheet or plate or ingot, it can be sufficient that only the contact surface of such sheet or plate or ingot is micro- or nanoporous and activated. On the other hand, anode elements which are in the basic shape of small spheres or cylinders or other granules, it is preferred that the whole (single) surface of such anode elements comprises a micro- or nanoporous and activated surface layer.

More specifically, in embodiments of the invention, the micro- or nanoporous activated surface layer has a thickness between 10 μm and 1 mm, preferably between 50 and 500 μm, and has a surface roughness between 200 nm and 500 μm, preferably between 1 and 100 μm. Nevertheless, it is to be noted that the invention is not limited to these ranges but can, e.g. in large generator units for industrial use, be implemented with values outside the above ranges.

In a process for making an anode element according to the invention, a pre-fabricated massive metal body is treated in at least one surface treatment step with at least one alkaline or acidic solution (e.g. etching material) for providing the micro- or nanoporosity and activation material for the activated state of the porous surface layer.

In an embodiment of the process of the present invention, the pre-fabricated massive metal body is treated (a) with an acid etch (e.g. etching material), in particular comprising chromic acid, and thereafter (b) with a hydrogen halide solution (e.g. activation material), in particular comprising hydrochloric acid. Further treatment steps can be provided, according to embodiments mentioned further below or in line with surface activation procedures.

In one further embodiment of the process, the or at least one surface treatment step comprises immersing the pre-fabricated massive metal body into a respective liquid or gas (e.g. etching material, activation material, oxidation material). Alternatively, the or at least one surface treatment step can be carried out by subjecting the surface or surfaces of the pre-fabricated massive metal body to a flow of a respective steam of the etching material, activation material, and/or oxidation material. In a further embodiment, prior to the surface treatment step a cleaning step is carried out, in particular a soaking the massive metal body into an alkaline solution (e.g. cleansing material). Even this step can be implemented by immersing the body into a bath of the respective solution or by subjecting its surface to a flow of a liquid solution or to a stream of a cleaning gas or steam, respectively.

In further embodiments, prior to step (a) and/or between steps (a) and (b) and/or after step (b) at least one rinsing step is carried out, in particular a rinsing with a rinsing material such as water (preferably deionised). Even this rinsing can be implemented in a steady rinsing solution or a flow of such solution or in a stream of such solution in its gaseous state.

Under the aspect of practical use, a further embodiment can be preferred wherein the or at least one surface treatment step for providing the micro-nanoporosity and the activated assembled state of the surface layer is carried out in an assembled configuration of the pre-fabricated massive metal body, preferably in a state wherein a plurality of pre-fabricated bodies is arranged in predetermined relationship to each other and/or to anode or catalyser bodies, respectively, of the fuel and electrical power generator unit. More specifically, the arrangement of anode elements and cathode or catalyser elements, respectively, of the fuel and electrical power generator unit can, after the last surface treatment step, be immediately inserted into tap water or a low-concentration saline solution for starting hydrogen and electrical power generation. If immediate hydrogen and electrical power generation is not required, the whole assembly or its individual parts separately can be dried out by compressed air, dryer, blower etc and will become reactive only upon immersion into aqueous conductive solution like water or saline solution.

A first aspect provided is an anode element for a fuel and electrical power generator unit, the anode element being formed as a massive metal body made from at least one of magnesium, zinc, or aluminum, or an alloy of at least one of these and comprising a micro- or nanoporous activated surface layer.

A second aspect provided is a process for making an anode element, wherein a pre-fabricated massive metal body is treated in at least one surface treatment step with at least one alkaline or acidic solution for providing the micro- or nanoporosity and the activated state of the surface layer.

A further aspect provided is an anode element formed as a body made from a material selected from at least one of magnesium, zinc, or aluminum, or an alloy of at least one of these and comprising a porous activated surface layer having an activation element preserved in pores formed by the material.

A further aspect provided is a method for generating hydrogen using an anode element formed as a body made from a material selected from at least one of magnesium, zinc, or aluminum, or an alloy of at least one of these and comprising a porous activated surface layer having an activation element preserved in pores formed by the material, the method comprising the steps of: exposing the anode element to a hydrogen source; chemically reacting the material forming the pores with the hydrogen source to generate the hydrogen; forming a subsequent activated layer in the material of the body adjacent to the porous activated surface layer during said chemical reacting; and chemically reacting the material in the subsequent activated layer with the hydrogen source to continue said generate the hydrogen.

A further aspect provided is a method for forming an anode element formed as a body made from a material selected from at least one of magnesium, zinc, or aluminum, or an alloy of at least one of these and comprising a porous activated surface layer having an activation element preserved in pores formed by the material, the method comprising the steps of: applying an etching material to an exterior surface of the body to cause the material to form the pores in the exterior surface; and applying an activation material to the formed pores to cause an activation element in the activation material to be preserved with the material of the formed pores in order to generate the porous activated surface layer.

A further aspect provided is a method for electrochemically reacting the anode element formed as a body made from a material selected from at least one of magnesium, zinc, or aluminum, or an alloy of at least one of these and comprising a porous activated surface layer having an activation element preserved in pores formed by the material, the method comprising the steps of: exposing the anode element to an electrolyte; chemically reacting the material forming the pores with the electrolyte; forming a subsequent activated layer in the material of the body adjacent to the porous activated surface layer during said chemical reacting; and continuing chemically reacting the material in the subsequent activated layer with the electrolyte.

### DESCRIPTION OF FIGURES

Further aspects and effects of the invention become clear from the more detailed explanation of embodiments on the basis of the attached drawings, of which

FIG. 1A shows an exploded view and FIG. 1B shows an assembled perspective view of a fuel and electrical power generating block according to the invention,

FIG. 2 shows a perspective view of the inner structure of a first component of the embodiment according to FIGS. 1A and 1B,

FIG. 3 shows a schematic diagram of a generator block according to FIG. 1B with peripheral components,

FIG. 4 shows a schematic diagram of a generator block according to FIG. 1B, embedded in an engine drive system,

FIG. 5 shows an example processing of an anode element of FIG. 1A,

FIG. 6 shows an example cross section of an embodiment of the anode element of FIG. 5, and

FIG. 7 shows an example alternative embodiment of the anode element of FIG. 1A.

### DESCRIPTION

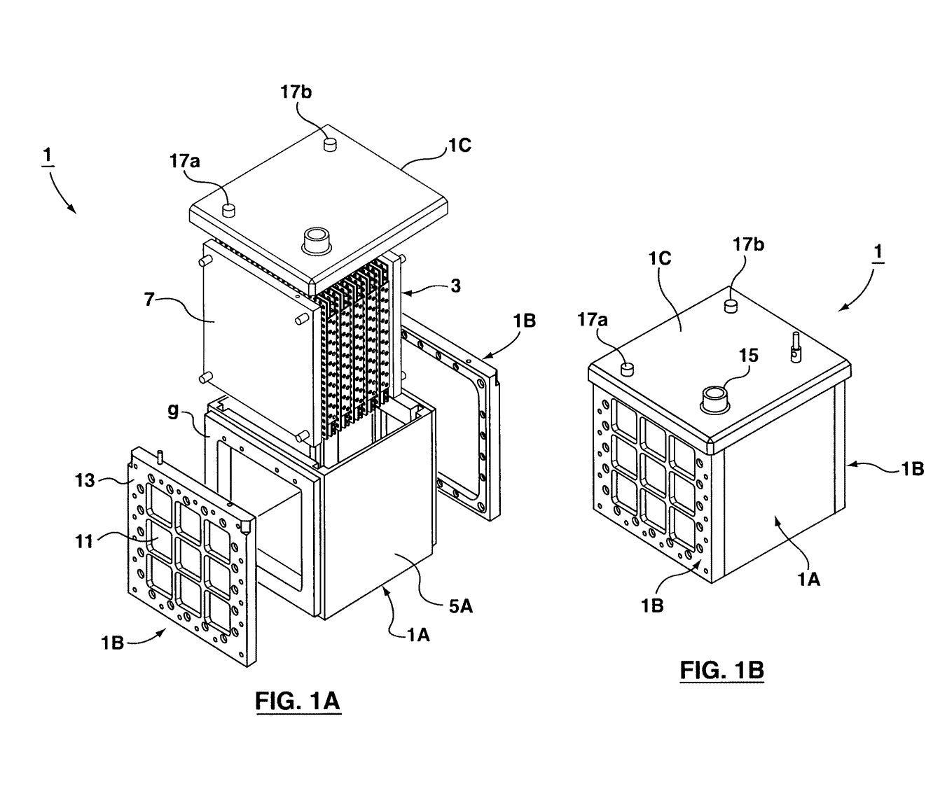

FIGS. 1A and 1B schematically illustrate, as an embodiment of the invention, a fuel and electrical power generating unit (generator block) 1, the outer shape of which is that of a cuboid and which comprises a larger first component 1A for generating hydrogen and two smaller second components 1B, attached to the first components at both ends thereof, for generating electrical power. A cover 1C covers both the first component 1A and the two second components 1B.

The first component 1A comprises a hydrogen generating block 3 arranged in a plastic housing portion 5A, and the respective components 1B each comprise an anode plate 7 (which in FIG. 1A is arranged as respective end plates of the hydrogen generating unit 3), a conductive (but partly insulated) frame 9, a membrane-like air cathode 11, and an outer end plate 13 made from plastic and over most of its surface having a grid shape. On the cover 1C, an outlet opening 15 for exhausting hydrogen produced in the first component and electrical contacts 17a, 17b for connecting the generator block 1 to an electrical load are provided.

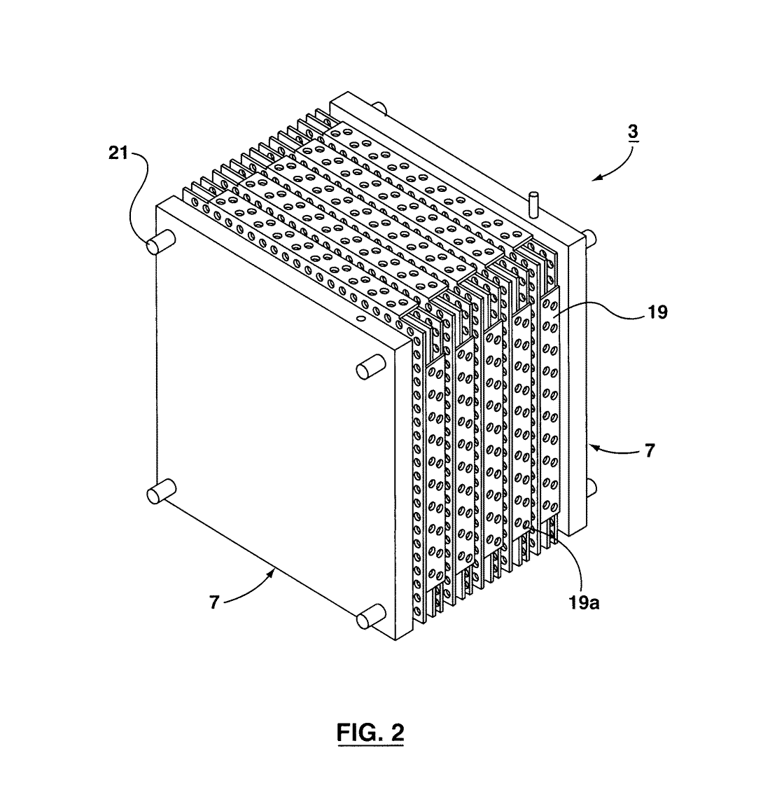

FIG. 2 separately illustrates the hydrogen generating block 3 of the first generator block component 1A, together with the end plates 7 which, according to their function, are part of the respective second generator block components 1B (as mentioned above). The exemplary hydrogen generator block comprises five sub-units 19 in a parallel arrangement to each other and to the end plates 7. In operation, the generator block 3 is arranged in the housing 5A of the first component 1A and immersed in sea water or an alkaline solution or another suitable electrolyte fluid (not shown).

The sub-unit 19 and the end plates 7 are stacked on each other at predetermined spacings and held by rods 21 provided close to the corners of the quadrangular plates or sub-units, respectively. As can be seen in FIG. 2, but described in more detail further below, each of the sub-units 19 has a 3-layer configuration, and most of the extension of their edges is covered with a rail 19a. All outer surfaces of each sub-unit 19 comprise a regular arrangement of through-holes making each of the outer surfaces liquid-permeable.

The end plates 7 are, in an exemplary embodiment, made from magnesium or an alloy thereof, whereas the outer surfaces of the sub-units 19 are made from stainless steel (or another iron alloy) and the rods 21 are made from zinc or an alloy thereof. Other materials can be chosen, depending on the specific operating conditions and taking performance requirements as well as cost constraints of the generator block into account.

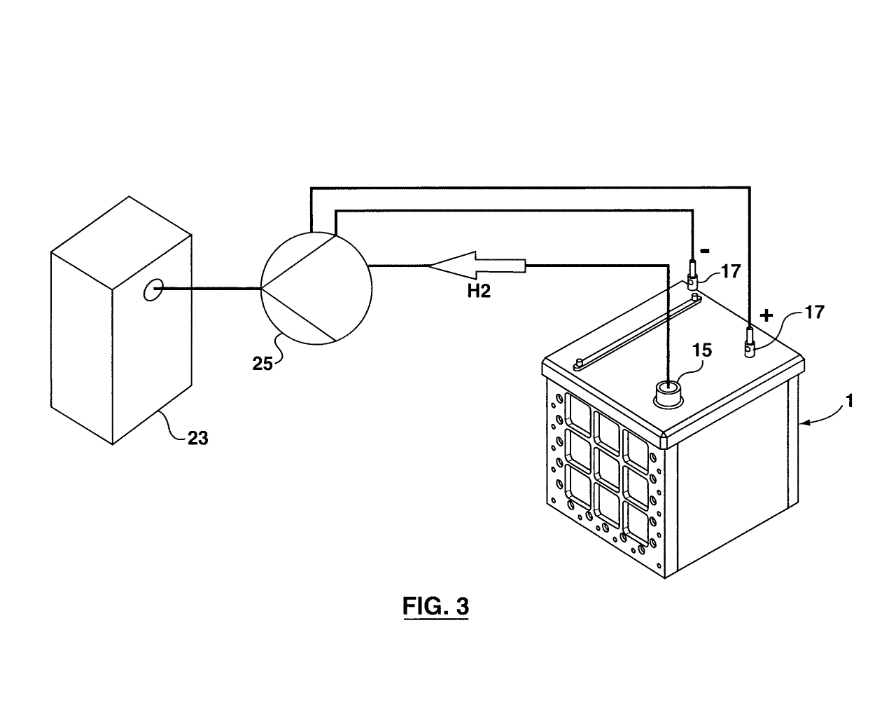

FIG. 3 schematically illustrates how a generator block 1 can be embedded in a technical system which includes a tank 23 as hydrogen storing means and a pump 25 for pumping hydrogen produced in the generator block 1 and exhausted through the hydrogen outlet 15 into the tank. The pump can (at least partly) be driven by electrical energy which is delivered by the generator block 1 itself, through its electrical contacts 17.

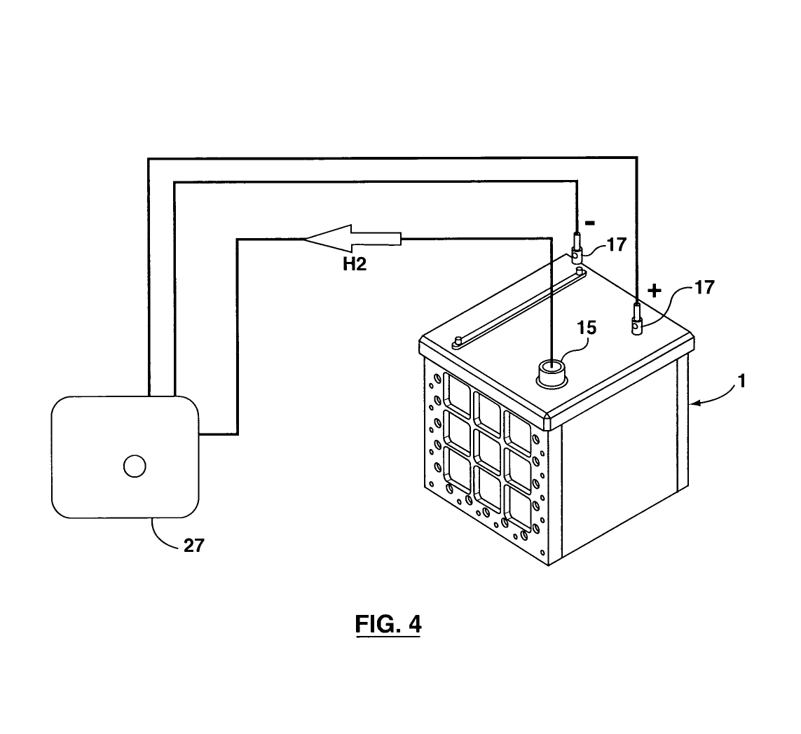

FIG. 4 schematically illustrates another system, wherein the generator block 1 is connected to a rotary combustion engine 27, via both the hydrogen outlet 15 and the electrical contacts 17, for delivering hydrogen for fuelling the combustion engine and electrical energy for operating the ignition and further electrical components thereof, to the engine.

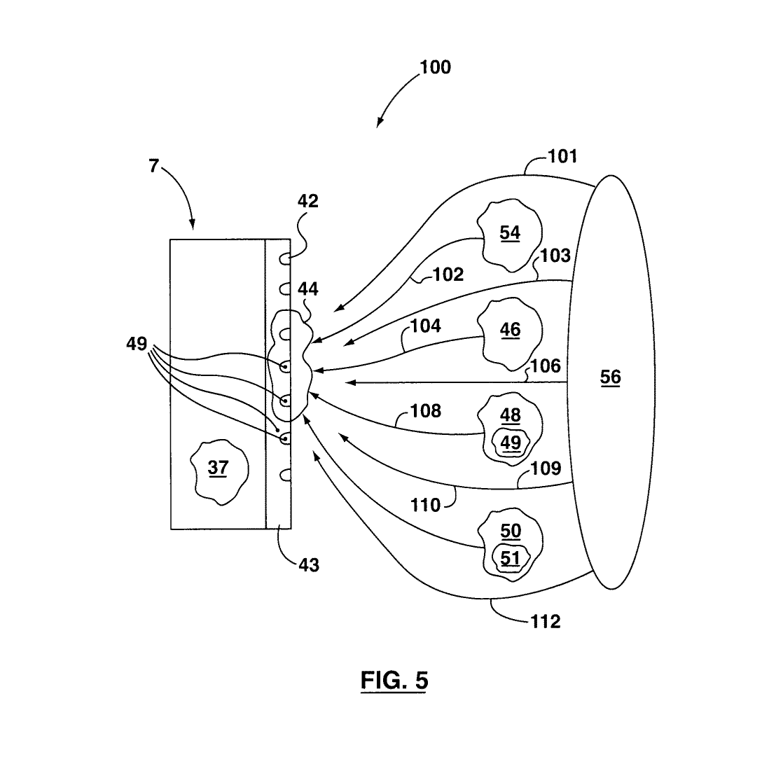

The hydrogen developing magnesium or magnesium alloy components 37 (see FIG. 5) of the above described generator unit or of similar units comprise a micro- or nanoporous and chemically activated surface layer 43. This layer 43 can, according to an embodiment of the process for making such component, be prepared from a pre-fabricated industrial grade magnesium body according to the following steps:
1) Soak (Alkaline) Cleaning for potential oil removal,
2) Water rinse
3) Acid Etch (Chromic Acid 5.76-6.7 oz/gal and Nitric Acid 7.6-10.6% v/v)
4) DI Water Rinse
5) HCL (Hydrochloric Acid 25%-50% (v/v)) Magnesium or its alloys upon immersion into diluted Hydrochloric Acid solution for at least 10 seconds releases H2 and forms a thermally activated magnesium layer as per the following equation:

Mg+2HCl→MgCl₂+H₂
During immersion into Hydrochloric Acid solution, Magnesium heats up within 10 sec up to 80 C.
6) DI Water Rinse.

Once a magnesium body 7 or, more specifically, a pre-fabricated arrangement of magnesium bodies 7 which has been treated in this way is immersed into an aqueous solution, in particular into salt water or even tap water, it can almost immediately start generating hydrogen from this electrolyte solution e.g. (hydrogen source), in accordance with the above-referenced reaction equation. The amount of hydrogen produced per time unit can be significantly higher than with the pre-fabricated body or bodies which have not been chemically treated to exhibit the activated surface layer 43. It is also recognised hat similar reaction equations can be realized for different metal/metal alloy materials 37 of the anode element 7, such but not limited to including zinc, aluminum and any alloys or mixtures thereof. For example, it is recognised that the material 37 of the anode element 7 can be of a single metal element types (e.g. magnesium or zinc or aluminum). For example, it is recognised that the material 37 of the anode element 7 can be an alloy of two or more metal element types (e.g. magnesium and/or zinc and/or aluminum). For example, it is recognised that the material 37 of the anode element 7 can be mixture of two or more metal element types (e.g. magnesium and/or zinc and/or aluminum). For example, it is recognised that the material 37 of the anode element 7 can be an alloy of one metal element type (e.g. magnesium or zinc or aluminum) and another one or more chemical element alloyed with the one metal element type. For example, it is recognised that the material 37 of the anode element 7 can be a mixture of one metal element type (e.g. magnesium or zinc or aluminum) and another one or more chemical element alloyed with the one metal element type. It is recognised that the hydrogen source can also be referred to interchangeably in the present description as an electrolyte, as desired. For greater certainty, the anode element 7 can be used or otherwise configured to react electrochemically with an electrolyte (having constituent elements other than including hydrogen). For greater certainty, the anode element 7 can be used or otherwise configured to react electrochemically with an electrolyte provided as a hydrogen source.

The best results with respect to the hydrogen generation and/or the electrical power generation can be achieved with a combined arrangement of chemically activated, porous hydrogen generating components (anode elements) and catalyser components (cathode elements). In such arrangements, catalyser or cathode elements, respectively, can be used which are known in the art, and in stacked plate configurations with alternating hydrogen developing plates and catalyser plates, as exemplified further above.

In a further exemplary embodiment of the manufacturing process of porous and activated anode elements, a pre-assembled plate stack or other pre-assembled arrangement of anode and cathode bodies can be subjected to the above sequence of steps or at least to selected steps from such sequence. For example, a pre-manufactured plate stack can be immersed into an acidic solution, such as hydrochloric acid or acetic acid or sulphuric acid, for a few seconds. Such treatment will, as a matter of fact, influence the cathode or catalyser components, respectively, of the arrangement, too, and it results in the rapid onset of hydrogen generation even in tap water and in a more powerful hydrogen and/or electrical power generation in conductive solutions or electrolytes, respectively, which are typically used in generator units of this type (e.g. sea water).

Referring to FIG. 5, shown is a surface treatment process 100 for forming the pores 40 (e.g. micro pores, nano pores, etc.) with activation in a surface 42 (e.g. the boundary of the anode body 7 in ordinary three-dimensional space between the material of the body 7 and the material of the surrounding environment) of the anode body 7 (e.g. also referred to as anode element or anode plate). The individual pores 40 in a group (e.g. as a pore collection or array 44, also referred to as a porous nano scale structure 44 or porous micro scale structure 44) form a surface layer 43 in the surface 42 by applying 104 (e.g. immersing, subjecting, etc.) an etching solution 46 to the surface 42, which causes the metal (or metal alloy) material 37 of the surface 42 to be non-uniformly dissolved thereby forming the individual pores 40 in the metal (or metal alloy) material 37 making up the surface layer 43. It is recognised that application of the etching solution 46 could be used to remove metal oxide present on the surface 42, thus exposing the pure unoxidized metal (or unoxidized metal alloy) material on the surface 42 for subsequent etching by the etching solution 46 in formation of the individual pores 40 of the pore structure 44 in the surface layer 43. Further, it is recognised that a total surface area of a non-porous surface 42 (pre-application of the etching material 46) would be less than a total surface area of the surface layer 43 containing the pore structure 44 (post application of the etching material 46), as presence of the individual pores 40 in the metal (or metal alloy) material 37 provide a textured format of the surface 42, hereafter referred to as the surface layer 43.

The anode material 37 can be, as exemplified above, magnesium. The anode material 37 can be an alloy containing magnesium. The anode material 37 can be aluminum. The anode material 37 can be an alloy containing aluminum. The anode material 37 can be zinc. The anode material 37 can be an alloy containing zinc. The anode material 37 can be a mixture of the elements of magnesium and aluminum. The anode material 37 can be a mixture of the elements of magnesium and zinc. The anode material 37 can be a mixture of the elements of zinc and aluminum. The anode material 37 can be a mixture of the elements of zinc and aluminum and magnesium.

A further step can be activation of the metal (or metal alloy) material 37 in the surface layer 43 by applying 108 (e.g. immersing, subjecting, etc.) to the porously configured surface layer 43 (containing the individual pores 40) an activation material 48 (e.g. a solution containing an activation element 49 such as a halide element 49 such as but not limited to Chlorine—Cl). The activation process of the surface layer 43 results in preserving (e.g. via chemical bonding) the activation element 49 along with the metal (or metal alloy) material 37 forming the pores 40 (e.g. throughout the porous structure 44 of the metal/metal alloy material exposed to the activation element 49) of the surface layer 43.

Depending upon the specific chemical reaction between the metal/metal alloy material 37 and the hydrogen source in the generation of hydrogen, the activation element 49 (present in the porous activated layer 43) can be referred to as a catalyst that is a substance that speeds up the chemical reaction between the hydrogen source and the metal/metal alloy material 37, whereby the catalyst is not be consumed by the chemical reaction. Hence the activation element 49 (when acting as catalyst) can be recovered chemically unchanged at the end of the reaction in the production of hydrogen the catalyst has been used to speed up, or otherwise catalyze.

Alternatively, depending upon the specific chemical reaction between the metal/metal alloy material 37 and the hydrogen source in the generation of hydrogen, the activation element 49 (present in the porous activated layer 43) can be referred to as a substance that only initiates the chemical reaction between the hydrogen source and the metal/metal alloy material 37, whereby the substance is consumed by the chemical reaction during the initiation. Hence the activation element 49 when acting as consumed substance at the initial stages of the reaction can not be recovered chemically unchanged at the end of the reaction (in the production of hydrogen) that the substance has been used to initiate. For example, the initial presence of the activation element 49, when acting as a consumed substance (or non-catalyst) can generate preferential reaction conditions (e.g. heat and/or temperature) of a sufficient level that can then be sustained during continued reaction of the remainder of the metal/metal alloy material 37 in the anode element 7 in the presence of the hydrogen source, once the initially exposed porous activated layer 43 has been consumed by the reaction with the hydrogen source.

In an embodiment of the anode element 7, the micro- or nanoporous activated surface layer 43 can comprise a halide 49 provided by the activation material 48, in particular chloride, of the respective anode metal. In other embodiments, resulting from activation mechanisms which are not based on hydrogen halides, the surface layer 43 can comprise other inorganic components 49 present in the activation material 48 and preserved in the formatted pores 40 of the surface layer 43 as the active element 49 (thus providing the activated surface layer 43) which facilitates the development of hydrogen when exposed to a hydrogen source (e.g. aqueous solution containing hydrogen) at the interface between the activated surface layer 43 and the hydrogen source. In other embodiments, resulting from activation mechanisms which are not based on hydrogen halides, the surface layer 43 can comprise other organometallic components 49 present in the activation material 48 and preserved in the metal (or metal alloy) material 37 of the formatted pores 40 of the surface layer 43, as the active element 49 (thus providing the activated surface layer 43) which facilitates the development of hydrogen from the hydrogen source (e.g. aqueous solution containing hydrogen) at the interface between the activated surface layer 43 and the hydrogen source.

The activation element 49 can be chemically reactive as a reagent with magnesium in the anode material 37. The activation element 49 can be chemically reactive as a reagent with aluminum in the anode material 37. The activation element 49 can be chemically reactive as a reagent with zinc in the anode material 37. The activation element 49 can be chemically reactive as a reagent with a mixture of the elements of magnesium and aluminum in the anode material 37. The activation element 49 can be chemically reactive as a reagent with a mixture of the elements of magnesium and zinc in the anode material 37. The activation element 49 can be chemically reactive as a reagent with a mixture of the elements of zinc and aluminum in the anode material 37. The activation element 49 can be chemically reactive as a reagent with a mixture of the elements of zinc and aluminum and magnesium in the anode material 37.

As such, it is recognised that the activation element 49 present/preserved in the porous surface layer 43 (via application of the activation material 48 to the pores 40 formed in the surface 42) converts the metal (or metal alloy) material 37 present in the surface layer 43 to be ready (e.g. catalyzed) to reactivate any hydrogen when exposed to the hydrogen source (e.g. aqueous solution such as water or hydrocarbon fuel, gaseous solution such as gaseous hydrocarbon fuel, etc.), and thus cause via electrolytic reaction the extraction (e.g. formation of hydrogen gas) from the other constituent elements (e.g. carbon in the case of carbon based fuels, oxygen in the case of water, etc.) present with hydrogen in the hydrogen source. As such, it is recognised that the presence of the pores 40 (formed in the metal (or metal alloy) material 37 of the surface 42 via application of the etching material 46) and the active element 49 (preserved in the layer 43 via the application of the activation material 48) in the porous (e.g. micro, nano, etc.) activated surface layer 43 provides for the material in the activated surface layer 43 (e.g. metal (or metal alloy) material 37) to aggressively react when exposed to the hydrogen source during extraction of hydrogen therefrom. As such, the provision of the activation element 49 in the activated surface layer 43 can be referred to as provision of a catalyst to catalyze the reaction of the metal (or metal alloy) material 37 in the formed pores 40 with the hydrogen present in the hydrogen source.

It is recognised that the anode element 7 can be provided as a massive metal body. The massive metal body 7 can be in the overall shape of a sheet or plate or ingot configured with the porous (e.g. micro- or nano) activated surface layer 43. The massive metal body 7 can be in the overall shape of a pair (e.g. via two plates) of opposing porous (e.g. micro- or nano) activated surface layers 43. In alternative embodiments, more specifically in embodiments wherein the hydrogen source (e.g. liquid, slurry, etc) contacts only a surface of the node element 7 (e.g. hydrogen developing sheet or plate or ingot body 7), it can be sufficient that only the contact surface of such configured anode element 7 is the porous (e.g. micro- or nano) activated surface layer 43. On the other hand, anode elements 7 which are in the basic shape of small spheres or cylinders or other granules, it can be preferred that the whole (single) surface 42 of such anode elements 7 comprises the porous (e.g. micro- or nano) activated surface layer 43. It is also recognised that the anode elements 7 can be provided as a collection of massive metal bodies 7, for example as a collection of metallic ore pieces provided as a collection in a mining operation. As such, the individual metallic ore pieces (or chunks) could be considered as the massive metal bodies 7, each having the porous (e.g. micro- or nano) activated surface layer 43 formed via one or more layer 43 formation process(es) as described using the application of the etching material 46 and the activation material 48.

Referring again to FIG. 5, HCL (Hydrochloric Acid 25%-50% (v/v)) can be provided as the activation material 48. For example, exposing the surface 42 containing the formed pores 40 in the metal (or metal alloy) material 37 (e.g. magnesium or its alloys) by immersion into the diluted Hydrochloric Acid solution (i.e. activation material 48) for a predefined period of time (e.g. at least 10 seconds) releases H2 from the activation material 48 and thereby forms a thermally activated porous metal (e.g. magnesium) activated layer 43 as per the following equation: Mg+2HCl→MgCl2+H2, thus providing for the preservation of the activation element 49 (in this case Chlorine by example only) in the activated layer 43 in association with the metal (or metal alloy) material 37 present in the pores 40 and corresponding porous structure 44. Thermal heating of the metal (or metal alloy) material 37 forming the pores 40 can be a result of the exothermic reaction of the activation material 48 with the metal (or metal alloy) material 37.

It is recognised that different acidic solutions can be used as the activation material 48 to activate the material 37 making up the pores 40 formed in the surface 42. One example activation material 48 is Sulphuric acid. One example activation material 48 is Nitric acid. One example activation material 48 is Acetic acid. One example activation material 48 is Lactic acid. As such, each of the activation material 48 types has a corresponding activation element 49 contained therein that reacts with the material 37 forming the pores 40 in order to preserve the activation element 49 with the material 37 of the pores 40.

It is recognised that liquid solutions containing at least 5% of Nickel Sulphate can be used as the activation material 48 to activate the material 37 making up the pores 40 formed in the surface 42. As such, Nickel sulphate, Nickel chloride, Zinc chloride and/or other salts can be used as the activation material 48 to activate the material 37 making up the pores 40 formed in the surface 42. For example, the concentration of the Nickel sulphate, Nickel chloride, Zinc chloride and/or other salts in the liquid solution as the activation material 48 can be preferably higher than 5% by volume. It is recognised that the higher the concentration of the liquid solution the stronger the preservation (e.g. higher concentration) of the activation element 49 with the material 37 of the formed pores 40 will be.

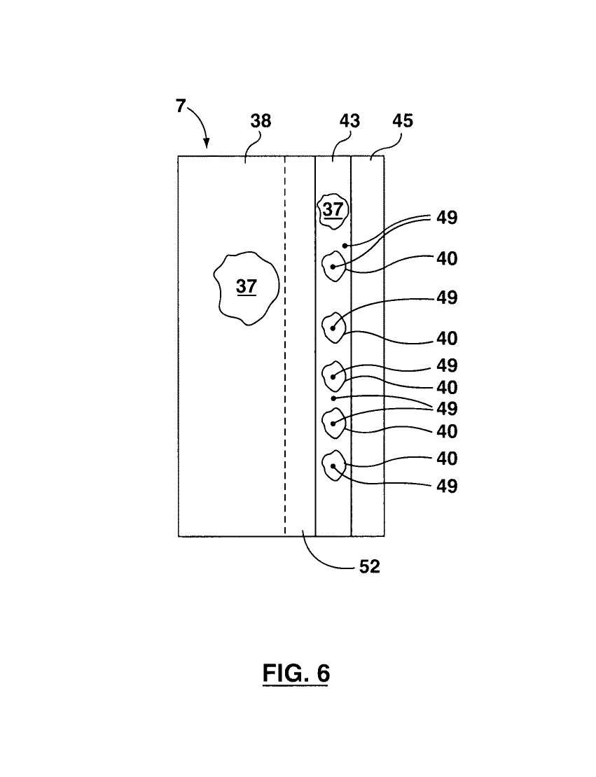

Referring again to FIG. 5, a further step can be applying 110 (e.g. immersing, subjecting, etc.) an oxidizing material 50 containing an oxidizing agent (e.g. oxygen) 51 to the porous activated surface 43 in order to form an metal oxide layer or oxidized layer 45 (e.g. MgO in the case of magnesium material 37 forming the pores 40 coming into contact with oxygen 51 in the oxidizing material 50), see FIG. 6. For example, the oxidizing agent 51 (also oxidant, oxidizer or oxidiser) can be the element (an atom or molecule made of a single type of atom) or compound (a molecule made of two or more different types of atoms) in an oxidation-reduction (redox) reaction that accepts an electron from another species (e.g. the metal (or metal alloy) material 37 forming the pores 40). Because the oxidizing agent 51 is gaining electrons (and is thus often called an electron acceptor), it is said to have been reduced. Oxygen is the prime (and eponymous) example among the varied types of oxidizing agents 51 of an example oxidizing material 50 (e.g. ambient air), however oxidizing materials 50 (e.g. chlorine trifluoride) may not necessarily donate or contain oxygen during the formation of the oxidized layer 45 of the anode element 7. It is also recognised that similar to the oxidizing agent 51, the activation element 49 can be provided as a chemical element (an atom or molecule made of a single type of atom) or compound (a molecule made of two or more different types of atoms) preserved in the activated porous layer 43.

Referring to FIG. 6, the finished anode element 7 (e.g. prior to use in a cell or otherwise exposed to the hydrogen source) can have a number of layers, such as but not limited to: 1) the underlying metal or metal alloy material 37 of the massive body (e.g. plate or ingot) providing an underlying metal/metal alloy substrate layer 38; 2) the porous activated surface layer 43 formed in the substrate 38 and containing the pores 40 formed by the metal/metal alloy material 37 also contained in the substrate layer 38; and optionally 3) the oxidized layer 45 (e.g. based on oxygen as the oxidizing agent 51).

More specifically, the porous activated surface layer 43 of the anode element 7 can have a thickness between 10 μm and 1 mm, preferably between 50 and 500 μm, and can have a surface roughness between 200 nm and 500 μm, preferably between 1 and 100 μm as a result of the formation of the porous structure 44. Nevertheless, it is to be noted that the anode element 7 is not limited to these ranges but can, e.g. in large generator units for industrial use, be implemented with values outside the above ranges. As further discussed below, when the activated surface layer 43 is placed in contact with the hydrogen source (e.g. saline solution), the metal/metal alloy material 37 is catalyzed by the presence of the activation element 49 to chemically react with the hydrogen source to generate hydrogen (e.g. hydrogen gas) therefrom. As the metal/metal alloy material 37 of the surface layer 43, and thus the surface layer 43 itself, is expended during reaction with the hydrogen source, the activation element 49 present in the surface layer 43 is used to activate the metal/metal alloy material 37 now available and exposed in the adjacent next layer 52 (see in ghosted view of FIG. 6) of the substrate layer 38, once the surface layer 43 has been used up in the generation of the hydrogen from the hydrogen source, to the remaining hydrogen source in contact with the anode element 7.

In view of the above described steps 104, 108, 110, the surface 42 treatment step 104 can comprise immersing the pre-fabricated massive metal body 7 into a respective etching material 46 (e.g. liquid). Alternatively, the surface 42 treatment step can be carried out by subjecting the surface 42 or surfaces 42 of the pre-fabricated massive metal body 7 to a flow or a respective stream of the respective etching material 46 (e.g. liquid, gas, steam, etc.). In view of the above described steps 104, 108, 110, the surface layer 43 activation step 108 can comprise immersing the pre-fabricated massive metal body 7 into a respective activation material 48 (e.g. liquid). Alternatively, the surface layer 43 activation step 108 can be carried out by subjecting the surface layer 43 containing the pores 40 of the pre-fabricated massive metal body 7 to a flow or a respective stream of the respective activation material 48 (e.g. liquid, gas, steam, etc.). In view of the above described steps 104, 108, 110, the surface layer 43 oxidation step 110 can comprise immersing the pre-fabricated massive metal body 7 into a respective oxidizing material 50 (e.g. liquid), thus forming the oxidation layer 45 on top of the porous activation layer 45. Alternatively, the surface layer 43 oxidation step 110 can be carried out by subjecting the surface layer 43 containing the pores 40 and activation element 49 of the pre-fabricated massive metal body 7 to a flow or a respective stream of the respective oxidation material 50 (e.g. liquid, gas, steam, etc.), thus forming the oxidation layer 45 on top of the porous activation layer 45. It is recognised that the oxidation layer 45 can be used to protect exposure of the porous activated layer 43 to environmental contaminants (until such time as the configured anode element 7 is exposed to the hydrogen source which acts to initially remove the oxidation layer 45 and thus expose and begin to chemically react with the metal (or metal alloy) material 37 present in the porous activated layer 43.

Referring again to FIG. 5, optional steps to those of steps 104 and 108 and 110 described above can include, prior to the surface treatment step 104, a cleaning step 102 is carried out, in particular soaking the surface 42 of the massive metal body 7 with a cleaning solution 54 (e.g. alkaline solution). Even this step 102 can be implemented by immersing the body into a bath of the respective solution or by subjecting its surface to a flow of a liquid solution or to a stream of a cleaning gas or steam of the cleaning solution 54, respectively. Further, between steps 102 and 104, and/or between steps 104 and 108 and/or between steps 108 and 110 optional rinsing step(s) 101,103,106,109,112 can be carried out, in particular with a rinsing agent 56 (e.g. water—preferably deionised). Even this rinsing step(s) 101,103,106,109,112 can be implemented in a steady rinsing solution or a flow of such solution or in a stream of such solution in its gaseous state.

As described above, it is recognised that the configured anode element 7 (e.g. with the porous activated surface layer 43 and optional oxidized surface layer 45) can be implemented in the environment(s) of providing the micro-nano porosity of the pores 40 and the activated assembled state of the surface layer 43 can be carried out in an assembled configuration of the pre-fabricated massive metal body 7, preferably in a state wherein a plurality of pre-fabricated bodies 7 is arranged in predetermined relationship to each other (e.g. as plates in an assembled generator cell 1, as a collection of ore bodies or chunks in a mining application, etc.) and/or to anode or catalyser bodies. More specifically, the arrangement of anode elements 7 and cathode or catalyser elements 11, respectively, of the fuel and electrical power generator unit 1 can, after the last surface treatment step, be immediately inserted into the hydrogen source (e.g. tap water or a low-concentration saline solution, hydrocarbon based fuel in liquid and/or gaseous form, a hydrocarbon based fuel in slurry form such as a coal slurry, etc.) for starting hydrogen and/or electrical power generation. If hydrogen and/or electrical power generation is not desired, the whole assembly or its individual parts separately of the anode element 7 can be dried out by compressed air, dryer, blower etc and can become subsequently reactive (e.g. precipitating the generation of hydrogen from the hydrogen source) upon reimmersion into the hydrogen source (e.g. aqueous conductive solution like water or saline solution). It is noted that upon removal from the hydrogen source of the anode element 7, after the oxidation layer 45 has been removed due to reaction with the hydrogen source, the oxidation layer 45 can reform if the anode element 7 is exposed to the oxidation material 50. It is also recognised that the hydrogen source can be a biofuel.

As an embodiment of the process 100 of FIG. 5, the hydrogen developing magnesium or magnesium alloy components 37 of the above described generator unit 1,3 or of more free form aggregations of multiple anode elements 7 in mining applications (e.g. collection of metal ore pieces or chunks) comprise a (e.g. micro- or nano) porous and chemically activated surface layer 43. This layer 43 can, according to an embodiment of the process for making such component, be prepared from a pre-fabricated industrial grade material 37 body according to the following steps:
1) step 102 Soak (Alkaline) Cleaning for potential oil or other surface 42 contaminant removal,
2) step 103 Water rinse
3) step 104 Acid Etch (using etching material 46 of Chromic Acid 5.76-6.7 oz/gal and Nitric Acid 7.6-10.6% v/v) to form the pores 40 out of the material 37 at the surface 42,
4) step 106 DI Water Rinse,
5) step 108 HCL (using activation material 48 of Hydrochloric Acid 25%-50 (v/v)) Magnesium or its alloys upon immersion into diluted Hydrochloric Acid solution for at least 10 seconds releases H2 and forms a thermally activated magnesium layer 43 as per the following equation:

Mg+2HCl→MgCl₂+H₂
During immersion into Hydrochloric Acid solution 47, Magnesium heats up within 10 sec up to 80 C and preserves the activation element with the material 37 of the formatted pores 40 in the surface layer 43, and.
6) step 109 DI Water Rinse.

Once a body 7 or, more specifically, a pre-fabricated arrangement of bodies 7which has been treated in this way is immersed into an aqueous solution (e.g. hydrogen source), in particular into salt water or even tap water, it can generate hydrogen from this solution by reacting the material 37 in the layer 43 with the hydrogen source, in accordance with the above-referenced example reaction equation. The amount of hydrogen produced per time unit can be significantly higher than with the pre-fabricated body or bodies which have not been chemically treated to provide the porous and activated surface layer 43.

Results with respect to the hydrogen generation and/or the electrical power generation via the generation unit 1,3 and/or more generically in mining applications can be facilitated with a combined arrangement of chemically activated, porous hydrogen generating components (anode elements 7) and catalyser components (cathode elements 11). In such arrangements, catalyser or cathode elements 11, respectively, can be used which are known in the art, and in stacked plate configurations with alternating hydrogen developing plates 7 and catalyser plates 11, as exemplified further above.

In a further exemplary embodiment of the manufacturing process of porous and activated anode elements 7, a pre-assembled plate stack or other pre-assembled arrangement of anode 7 and cathode 11 bodies can be subjected to the above sequence of steps or at least to selected steps from such sequence. For example, a pre-manufactured plate 7,11 stack can be immersed into the etching material 46 and/or the activation material 48 as an assembled anode/cathode stack (e.g. an acidic solution, such as hydrochloric acid or acetic acid or sulphuric acid), for a predetermined time (e.g. a few seconds) in order to form the pores 40 and preserve the activation element 49 with the material 37 making up the pores 40 in the now porous activated surface layer 43 of the anode element(s) 7 in the assembly. Such treatment can influence the cathode or catalyser 11 components, respectively, of the arrangement, too, and can result in the assisted onset of hydrogen generation even in tap water and in a more powerful hydrogen and/or electrical power generation in conductive solutions or electrolytes, respectively, which are typically used in generator units of this type (e.g. sea water).

It is recognised that the anode element 7 containing the activated porous surface layer 43 (i.e. containing the pores 40—also referred to as micro pores 40 or nano pores 40) can be used in a generating unit 1 (see FIG. 1) configured as a hydrogen generator containing anode elements 7 (e.g. plates of magnesium or an electrochemically comparable material with porous activated surface 43), optionally plates of an electrochemically passive material in an electrolyte, for example a saline solution, and cathode element(s) 11. For example, the anode element 7 can be used for a fuel and electrical power generator unit 1, in which conductive water or other conductive aqueous solution (e.g. hydrocarbon based fuel) is used as an electrolyte and hydrogen source (not shown).

In the above described process, the material 37 of the surface 42 of the anode element 7 (e.g. magnesium or its alloys) are treated by the etching material 46 in such a way that pores 40 are formed in chaotic gaps based on the metal material 37 (e.g. magnesium) composition. During the chemical processing using the etching material 46 of the material 37 of the surface 42 of the anode element 7 (e.g. magnesium or its alloys), we create porous surface layer 43 with pores 40 measuring by example only a few nanometres in diameter to those measuring approximately 75 nanometers and up based on time of immersion in the etching material 46. As soon as activated anode (treated magnesium) extracted from activated solution (Acid) its surface forming protective Magnesium oxide (MgO) layer stabilizing the alloy. After re immersion of treated magnesium or its alloy into any aqueous solution magnesium oxide dissolves exposing the nano pores and initiate hydrogen extraction.

As discussed above, the hydrogen source that is exposed to the porous activated surface layer 43 of the anode element 7 can be any number of different hydrogen containing materials (e.g. liquid, slurry, gas and/or mixture thereof). As such, the anode element 7 can be deposited into, or otherwise exposed to such as a stream, liquid fuel such as Gasoline, Diesel, GP8, Kerosene, Ethanol. Once the activated surface layer 43 comes into contact with the hydrogen source, the hydrogen extraction/generation from the hydrogen contained in the hydrogen source occurs through chemical reaction of the material 37 and subsequent chemical dissolution of the material 37 in the porous activated surface layer 43. This hydrogen extraction/generation process can be especially efficient with fuels or any other aqueous solutions as the hydrogen source having PH of 7 and lower (hence classified as an acidic hydrogen source). For example, the lower the PH value of the hydrogen source, the stronger and more efficient the hydrogen extraction can become. Further, it is recognized that the hydrogen extraction/generation through reaction with the material 37 in the porous activated surface layer 37 can be performed similarly with fuels like gasoline or bio fuels or any other fuels or aqueous solutions were PH is not traditionally measurable.

Also hydrogen extraction can occur with the anode element 7 used without a corresponding cathode element 11 as part of the generating unit 1,3. Also hydrogen extraction can occur with the anode element 7 used with the corresponding cathode element 11 as part of the generating unit 1,3. In particular, coal liquid slurry can be used as the hydrogen source with generating units 1,3 containing the anode element 7 and the cathode element 11, for example in flow through configuration such that a flow of coal slurry flows past the anode element 7 or is otherwise agitated about the anode element 7. In particular, coal liquid slurry can be used as the hydrogen source with generating units 1,3 containing the anode element 7 and the cathode element 11, for example in a flow through configuration such that a flow of coal slurry flows past the anode element 7 without the cathode element 11 or is otherwise agitated about the anode element 7. Instead of coal slurry, the hydrogen source can be black water.

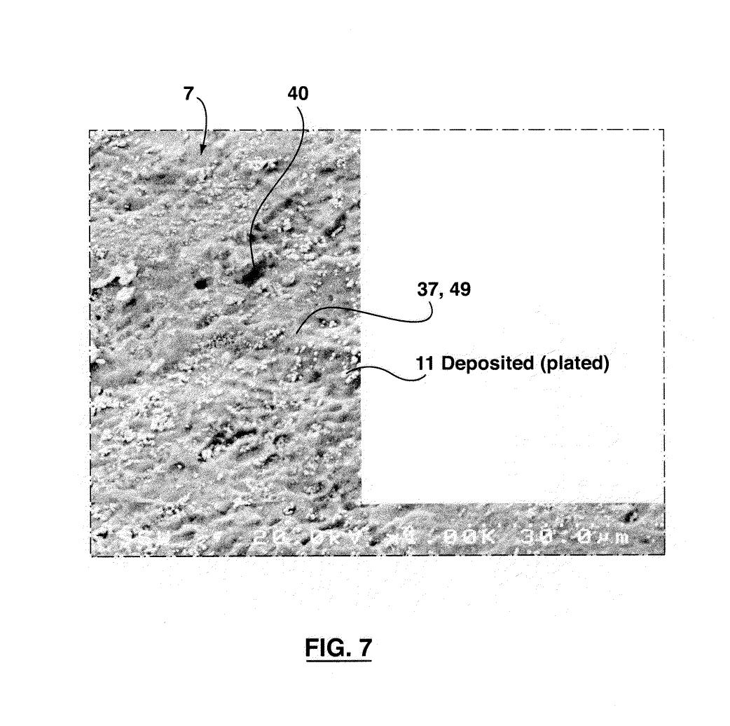

The cathode element 11 can be comprised of stainless steel mesh, steel mesh, copper mesh, aluminum mesh, titanium mesh or any other metallic or non metallic alloy can be selected as preliminary base material. By depositing on above listed mesh Zinc Nickel Chloride or Zinc Nickel Alkaline at least 0.0001″ layer of coating or Nickel Strike following any other forms of Nickel deposit (Ni) or Nickel Alloys such as (Nickel Sulphamate, Nickel Cobalt, Nickel Phosphorous (NiP compound, with 7-12% phosphorus content or as low as 4%) and other. NiP compound, with 7-12% phosphorus content or as low as 4% can be the Cathode element 11 (Catalyser) in hydrogen extraction process. Referring to FIG. 7, shown is an anode element 7 having the metal (or metal alloy) material 37 in the surface layer having the pores 40, the preserved activation elements 49 and optionally the deposited cathode material 60. It is recognised that the deposited cathode material 60 deposited on the surface layer 43 of the anode element 7 can be provided in micro deposits (e.g. collections of particles) distributed over the surface layer 43. It is recognised that the deposited cathode material 60 deposited on the surface layer 43 of the anode element 7 can be provided in macro deposited regions (e.g. formed integral areas such as strips, patches, etc.) distributed over the surface layer 43. However any other Nickel or Nickel alloys compositions for the cathode element 11 can have suitable electrical properties. The cathode element 11 can also be graphite solid or perforated.

As such, the presence of the cathode material 60 provided on the body of the anode element 7 in conjunction with the porous material 37 and the preserved activation element 49 (see FIG. 7) in the activated surface layer 43 can provide for the electrolytic reaction of the anode element 7 (i.e. when exposed of the surface layer 43 to the hydrogen source) to be enhanced with presence of Cathode (Catalyser) material 60. Other words, you have anode material 37 and the cathode material 60 in one body exposed as the anode element 7 in the hydrogen source.

As such, the catalyser material 60 (see FIG. 7) deposited on the material 37 of the surface layer 43 can be provided by an actual chemical and/or electrochemical deposition of listed below alloys on the material 37 (e.g. magnesium or magnesium alloys). For example, the process of depositing the material 60 on the surface layer 43 of the anode element 7 can be Alkaline cleaning/soak cleaning, Water Rinse, Chromic Acid Etch, or (Alkaline Etch following Bismuth De smut), Water Rinse, Manganese Phosphate Cobalt (Mn,Co)PO₄ or (Zincate), Water Rinse, (Woods or Alkaline or Sulphamate) Nickel Strike, Water Rinse, Zinc-Nickel, Zinc-Iron, Zinc-Cobalt, Cadmium, Copper, Nickel/Cobalt ((NiCo) or Electroless Nickel with cobalt (ENCo)), Water Rinse, Air Dry. It is recognised that the thickness of the deposited cathode material 60 can be less than 1 micron.

As such, the material 37 (e.g. magnesium or its alloy) along with above listed deposited cathode material 60 can trigger the hydrogen extraction from aqueous solutions like pre-treated magnesium in Acids when the anode element 7 is exposed to the hydrogen source. An even more powerful reaction in combination with Cathode (Catalyser) material 60 can be done by manufacturing the anode element 7 by:

1) optional Soak (Alkaline) Cleaning for potential oil removal,

2) optional Water rinse,

3) Acid Etch 46 (Chromic Acid 5.76-6.7 oz/gal and Nitric Acid 7.6-10.6% v/v) Alkaline etch 46 can be also used.

4) optional Water Rinse.

5) Manganese Phosphate Cobalt (Mn,Co)PO₄

Or alternately

5) Zincate

6) optional Water Rinse

7) Woods or Alkaline or Sulphamate Nickel Strike

8) One of the listed as the material 60: Zinc-Nickel, Zinc-Iron, Zinc-Cobalt, Cadmium, Copper, Nickel/Cobalt ((NiCo) or Electroless Nickel with cobalt (ENCo)).

Preferably the reaction of the anode element 7 with the hydrogen source can be facilitated with Nickel/Cobalt selected as the deposited material 60.

As mentioned above, as the material 37 of the pores 40 in activated surface layer 43 is expended in production of the hydrogen from the hydrogen source, subsequent adjacent layers 52 are formed and then expended in the material 37 of the substrate 38 as a result of the chemical reaction of hydrogen formation. It is recognised that the presence of the activation element 49 in the initial activated surface layer 43 can be used to activate the subsequent layers 52 as the activation element 49 present in the previous layer 43,52 becomes available and exposed to the subsequent layer(s) 52 as the material 37 in the previous layer(s) 43,52 is used up during the chemical reaction with the material 37 to generate the hydrogen. This process of using up subsequent layers 52 of the anode element 7 (e.g. like peeling layers of an onion) continues (as long as there is available hydrogen in the hydrogen source) until all of the material 37 present and available for reaction to generate the hydrogen is used up. It is recognised that the subsequent layers 52 may or may not include pores 40 formed therein as the hydrogen is generated during use of the anode element 7 in contact with the hydrogen source.

It is recognised that the activation material 48 can be a compound containing the activation element 49 and the same material 37 as in the anode element 7 (e.g. material 37 forming the pores 40 in the surface layer 43 and/or in the substrate layer 38). It is also recognised that the anode element 7 can have different materials 37 provide as different layers throughout a thickness of the body of the anode element 7.

Referring again to FIG. 5, the anode element 7 can be formed as a body made from a material 37 selected from at least one of magnesium, zinc, or aluminum, or an alloy of at least one of these and comprising a porous activated surface layer 43 having an activation element 49 preserved in pores 40 formed by the material 37. The pores can be of a micro or nano size in dimension (e.g. diameter). The anode element 7 can have the oxidation layer 45 covering the porous activated surface layer 43. The activation element 49 can be a halide obtained from a solution containing the material 37 and the halide.

A method for generating hydrogen using the anode element 7 formed as a body made from the material 37 selected from at least one of magnesium, zinc, or aluminum, or an alloy of at least one of these and comprising the porous activated surface layer 43 having the activation element 49 preserved in pores 40 formed by the material 37 can include the steps of: exposing the anode element 7 to a hydrogen source; chemically reacting the material 37 forming the pores 40 with the hydrogen source to generate the hydrogen; forming a subsequent activated layer 45 in the material 37 of the body adjacent to the porous activated surface layer 43 during the chemical reacting; and chemically reacting the material 37 in the subsequent activated layer 45 with the hydrogen source to continue the generation of the hydrogen. The hydrogen source can contain water. The hydrogen source can be a hydrocarbon based fuel. The hydrogen source can be a coal slurry. The porous activated surface layer can be covered by the oxidation layer 45 composed of the oxidizing element 49 and the material 37, such that prior to the step of chemically reacting the material 37 forming the pores 40, chemically reacting the oxidation layer 45 with the hydrogen source in order to expose the adjacent activated surface layer 43 to the hydrogen source.

Further, a method for forming the anode element 7 formed as a body made from the material 37 selected from at least one of magnesium, zinc, or aluminum, or an alloy of at least one of these and comprising the porous activated surface layer 43 having the activation element 49 preserved in pores 40 formed by the material 40 can include: applying the etching material 46 to an exterior surface 42 of the body 38 to cause the material 37 to form the pores 40 in the exterior surface 42; and applying the activation material 48 to the formed pores 40 to cause the activation element 49 in the activation material 48 to be preserved with the material 37 of the formed pores 40 in order to generate the porous activated surface layer 43. Further, an optional step can be applying an oxidation material 50 having an oxidizing element 51 to the porous activated surface layer 43 in order to chemically react with the material 37 in the porous activated surface layer 43 to form an oxidation layer 45 covering the porous activated surface layer 43.

A further method can be for electrochemically reacting the anode element 7 formed as a body made from a material selected from at least one of magnesium, zinc, or aluminum, or an alloy of at least one of these and comprising a porous activated surface layer 43 having an activation element 49 preserved in pores 40 formed by the material 37, the method comprising the steps of: exposing the anode element 7 to an electrolyte (e.g. one example being a hydrogen source); chemically reacting the material forming the pores with the electrolyte (e.g. for the purpose of electricity generation, for the purpose of using electrolysis causing a breakdown of the electrolyte into its constituent parts, etc.); forming a subsequent activated layer in the material of the body adjacent to the porous activated surface layer during said chemical reacting; and continuing chemically reacting the material in the subsequent activated layer with the electrolyte. One example of the constituent parts of the electrolyte is hydrogen and oxygen for water as an electrolyte exposed to the anode element 7.

Provided are magnesium or its alloys pretreated for introduced porosity on an exterior surface 42 as a configured anode element 7, and/or activation of the surface 42 using preservation of an activation material 49 of the metal material 37 comprising the formed pores 40 of the porosity, and/or the porous and activated surface layer 43 plated (e.g. distributed micro surface layer deposits 60, localized macro-regions 60 of metals deposited on the surface layer 42, etc.) with metals acting as catalysts 11 providing maintaining of low conductivity during idling and upon getting a demand from a consumable hydrogen source (e.g. Motor/Engine). As such the whole anode surface layer 43 can become highly conductive for use as a consumable/sacrificial anode in an electrochemical reaction with a hydrogen source of other electrolytic solution to which the anode is exposed. It is recognised that the hydrogen source can also be referred to as an electrolyte.

The embodiments and aspects of the invention explained above are not determined to limit the scope of the invention, which is exclusively to be determined by the attached claims. Many modifications of the inventive concept are possible within the scope of the claims and, more specifically, arbitrary combinations of the several claim features are considered to be within the scope of the invention.

What is claimed is:

1. An anode element for a fuel and electrical power generator unit, the anode element being formed as a massive metal body made from at least one of magnesium, zinc, or aluminum, or an alloy including at least one of the foregoing, and comprising a micro- or nanoporous activated surface layer.

2. The anode element of claim 1, wherein the micro- or nanoporous activated surface layer comprises a halide of the respective anode metal.

3. The anode element of claim 1, wherein the massive metal body is in the overall shape of a sheet or plate or ingot and comprises two opposing micro- or nanoporous activated surface layers.

4. The anode element of claim 1, wherein the micro- or nanoporous activated surface layer has a thickness between 10 μm and 1 mm, and has a surface roughness between 200 nm and 500 μm.

5. A process for making an anode element according to claim 1, which comprises surface treating a pre-fabricated massive metal body with at least one alkaline or acidic solution for providing the micro- or nanoporosity and the activated state of the surface layer.

6. The process of claim 5, wherein the pre-fabricated massive metal body is surface treated (a) with an acid etch and thereafter (b) with a hydrogen halide solution.

7. The process of claim 6, wherein the surface treating comprises immersing the pre-fabricated massive metal body into one or more liquids.

8. The process of claim 6, wherein the surface treatment step comprises subjecting one or more surfaces of the pre-fabricated massive metal body to a flow of a respective steam.

9. The process of claim 6, which further comprises cleaning the massive metal body before the surface treating by soaking the massive metal body in an alkaline solution.

10. The process of claim 6, which further comprises rinsing the massive metal body with water.

11. The process of claim 5, wherein the surface treating is carried out in an assembled configuration of a plurality of the pre-fabricated massive metal bodies such that the plurality of pre-fabricated bodies is arranged in predetermined relationship to each other and/or to anode or catalyser bodies, respectively, of the fuel and electrical power generator unit.

12. The process of claim 11, wherein the arrangement of anode elements, and/or catalyser elements, respectively, of the fuel and electrical power generator unit is, after a last surface treating, immediately inserted into tap water or a low-concentration saline solution for starting hydrogen and electrical power generation.

13. The process of claim 11, which comprises drying the pre-assembled configuration after the last surface treating of the anode element.

14. The anode element of claim 1 further comprising an oxidation layer over the micro- or nano-porous activated surface layer.

15. An anode element formed as a body made from a material comprising at least one of magnesium, zinc, or aluminum, or an alloy including at least one of the foregoing, and comprising a porous activated surface layer having an activation element preserved in pores formed by the material.

16. The anode element of claim 15, wherein the pores are of a micro or nano size.

17. The anode element of claim 15 further comprising an oxidation layer covering the porous activated surface layer.

18. The anode element of claim 15, wherein the activation element is a halide obtained from a solution containing the material and the halide.

19. A method for generating hydrogen using an anode element formed as a body made from a material selected from at least one of magnesium, zinc, or aluminum, or an alloy including at least one of the foregoing, and comprising a porous activated surface layer having an activation element preserved in pores formed by the material, which method comprises:
exposing the anode element to a hydrogen source;
chemically reacting the material forming the pores with the hydrogen source to generate the hydrogen;
forming a subsequent activated layer in the material of the body adjacent to the porous activated surface layer during said chemical reacting; and
chemically reacting the material in the subsequent activated layer with the hydrogen source to continue said generate the hydrogen.

20. The method of claim 19, wherein the hydrogen source contains water.

21. The method of claim 19, wherein the hydrogen source is a hydrocarbon based fuel.

22. The method of claim 19, wherein the hydrogen source is a coal slurry.

23. The method of claim 19, wherein the porous activated surface layer is covered by an oxidation layer composed of an oxidizing element and the material.

24. The method of claim 23 which further comprises, prior to chemically reacting the material forming the pores, chemically reacting the oxidation layer with the hydrogen source to expose the adjacent activated surface layer to the hydrogen source.

25. A method for forming an anode element formed as a body made from a material selected from at least one of magnesium, zinc, or aluminum, or an alloy including at least one of the foregoing, and comprising a porous activated surface layer having an activation element preserved in pores formed by the material, which method comprises:
applying an etching material to an exterior surface of the body to cause the material to form the pores in the exterior surface; and
applying an activation material to the formed pores to cause an activation element in the activation material to be preserved with the material of the formed pores in order to generate the porous activated surface layer.

26. The method of claim 25 which further comprises applying an oxidation material having an oxidizing element to the porous activated surface layer to chemically react with the material in the porous activated surface layer to form an oxidation layer covering the porous activated surface layer.

27. A method for electrochemically reacting an anode element formed as a body made from a material selected from at least one of magnesium, zinc, or aluminum, or an alloy including at least one of the foregoing, and comprising a porous activated surface layer having an activation element preserved in pores formed by the material, which method comprises:
exposing the anode element to an electrolyte;
chemically reacting the material forming the pores with the electrolyte;
forming a subsequent activated layer in the material of the body adjacent to the porous activated surface layer during said chemical reacting; and
continuing chemically reacting the material in the subsequent activated layer with the electrolyte.
